(19) United States
(12) Patent Application Publication
(10) Pub. No.: US 2013/0305222 A1
(43) Pub. Date: Nov. 14, 2013

(54) Development System

(71) Applicants: Onur Cinar, Mountain View, CA (US); Nizamettin Gok, San Jose, CA (US); Sriraman Krishnamoorthy, Cupertino, CA (US)

(72) Inventors: Onur Cinar, Mountain View, CA (US); Nizamettin Gok, San Jose, CA (US); Sriraman Krishnamoorthy, Cupertino, CA (US)

(73) Assignee: Microsoft Corporation, Redmond, CA (US)

(21) Appl. No.: 13/470,071

(22) Filed: May 11, 2012

(51) Int. Cl. G06F 9/44

(52) U.S. Cl. 717/124

(57) ABSTRACT

A method for remotely testing an application on a device is disclosed. The method includes connecting a development system to the device. The device is hosted in a remote environment and is not directly accessible to the development system. The development system connects to the device via an agent that is coupled to the device, wherein the agent is configured to receive application data for the device and control signals from the development system and operate the device according to the control signals. The method further includes fetching the collected device data from the device, wherein the agent is configured to collect the device data from the device and the development system retrieves the collected device data from the agent.

### BACKGROUND

In computing, the term platform is the name given to a combination of computer hardware, computer architecture, and operating system that are used to run software applications. Software applications are written to depend on the features and the programming interfaces of a particular target platform. These software applications are referred to as native software applications to emphasis their high degree of dependencies to their host platforms. Native software applications require a new architecture and new software code, most likely in a new programming language, in order to support a new target platform. The production of native software applications that target multiple platforms requires longer development cycles, and diverse development teams. Maintenance and improvements on native software applications requires coordination between all platform development teams, and they are prone to inconsistencies.

In computing, cross platform is an attribute conferred to methods, concepts, and software that are implemented to operate on multiple computer platforms or multiple devices. Software applications that are designed and developed based on these principals are referred to as cross platform software applications. Cross platform software applications can either run as-is, or they can be compiled as native software to run on each new target platform. The production of cross platform software applications that target multiple platforms requires shorter development cycles and can be carried on by a single team. Maintenance and improvement of cross platform applications can be carried over by individual teams, and is generally not prone to inconsistencies due to common software code base.

Web applications are typically described as cross platform because they are accessible through commonly available web browsers running on diverse computer platforms. Web applications are developed using interpreted computer programming languages that are processed by web browsers at run-time and does not require to be compiled as native software applications for each target platform. Web browsers provide a platform independent virtual execution environment with consistent features and programming interfaces to allow web applications to seamlessly operate without the need to know the underlying platform.

Web browser is a common name that is given to software applications for traversing, retrieving, executing, and presenting world wide web resources. Due to the vast feature requirements in each of these areas, modern web browsers rely on other third party modules to deliver some of these functionalities. There are numerous third party vendors providing web rendering engines, software interpreters, and media players. Web browsers choose and employ these third party modules based on their target platform. In other words, two web browsers coming from the same software vendor but running on different platforms may contain different rendering, execution, and media player modules. The number of web browser vendors, and the high degree of the combinations of sub modules that are in use make the web browser market highly fragmented.

World Wide Web Consortium, also known as W3C, is the organization that was formed to define the standards for World Wide Web technologies in order to ensure consistencies among all web browsers and technologies. W3C, in collaboration with other standards bodies, provides standards for web browsers. However, since W3C is not an official regulatory body, the web browser vendors are free to decide the level of their compliance with W3C standards.

The chosen level of compliance with W3C standards, and the disagreeing interpretation of these standards by the web browser developers, degrades the cross platform nature of web applications. In order to deal with these nuances appropriately and still provide a consistent user experience among all platforms, advanced web applications are required to detect the target web browsers, and follow a different communication based on the web browser's vendor, version, revision, and the platform. This is a well known problem in web application development field. Due to the vast number of browsers and their revisions, there is no solution to address these nuances methodically. In order to address these nuances promptly, and make appropriate architectural and logical decisions, web application developers are required to frequently run their applications on multiple web browsers (and platforms) to detect and address any inconsistencies. Desktop-based web browsers provide tools to report problems and to allow diagnosis of the web applications. These advanced features require additional CPU cycles, memory, disk space, and power, which can be achieved easily on desktop platforms.

Mobile web browsers are designed and developed with a different set of requirements compared to desktop web browsers. Mobile platforms come with slower CPU units, lower memory and disk space, and limited battery power. Extensive usage of the CPU unit and the disk drivers are known to consume the battery power at high degrees. In order to provide a reasonable and pleasing web browsing experience, the mobile web browsers are carefully developed with a minimalist approach. Most of the advanced development tools that are available in desktop browsers are not available in mobile browsers. This makes mobile web application development to require longer development cycle, due to the limited access to browser internals and non-availability of diagnostic tools.

There are different types of computing devices in the market these days. Many mobile phones and devices such as iPhone, Android Phones, Windows Phones, etc. are used for running computer applications that were traditionally used to be run on desktop/laptop computers. Many user interface rendering technologies (e.g., HTML, HTML5, etc.) are used these days to build web applications. Devices generally include custom rendering engines or webkits to render the user interface of web applications. Many of these rendering engines render an user interface of a display based on specific hardware and software characteristics of a device. Due to these differences in the rendering of user interfaces, display of same application (for example, a Web application) appear different on different devices. For example, one device may display an application properly while the other device may not. For example, on one device, the user interface controls may appear perfectly aligned while on a different device, the alignment may be unaligned.

### SUMMARY

In one embodiment, a method for remotely testing an application on a device is disclosed. The method includes connecting a development system to the device. The device is hosted in a remote environment that is not directly accessible to the development system. The development system connects to the device via an agent that is coupled to the device, wherein the agent is configured to receive application data for the device and control signals from the development environment and operate the device according to the control signals. The method further includes collecting device data from the device, wherein upon instructions from the development environment, the agent collects the device data from the device and the development environment fetches the collected data from the agent. The device data can include device runtime parameters, device temperature, central processing unit (CPU) data, memory data, device configuration data, and the like.

In another embodiment, a computer readable storage medium containing a program which, when executed, performs an operation of remotely testing an application on a device, is disclosed. The operation includes connecting a development system to the device. The device is hosted in a remote environment which is not directly accessible to the development system. The development system connects to the device via an agent that is coupled to the device, wherein the agent is configured to receive application data for the device and control signals from the development environment and operate the device according to the control signals. The operation further includes collecting device data from the device, wherein upon instructions from the development environment, the agent collects the device data from the device and the development environment fetches the collected device data from the agent.

In yet another embodiment, a system for remotely testing an application on a device a development system for developing and testing programming instructions is disclosed. The system includes a provider coupled to the development system and an agent coupled to the device. The device is hosted in a remote environment and is not directly accessible to the development system. The development system is configured to connect to the device via the agent, wherein the agent is configured to receive application data, including programming instructions to be deployed on the device and control signals from the development system and operate the device according to the control signals. The development system is configured to cause the agent to collect device data from the device, the agent is configured to collect the device data from the device according to the control signals received from the development system. The development system is also configured to fetch the collected device data from the agent Other embodiments include, without limitation, a non-transitory computer-readable storage medium that includes instructions that enable a processing unit to implement one or more aspects of the disclosed methods as well as a system configured to implement one or more aspects of the disclosed methods.

### BRIEF DESCRIPTION OF THE DRAWINGS

So that the manner in which the above recited features of the various embodiments can be understood in detail, a more particular description of the various embodiments, briefly summarized above, the appended drawings. It is to be noted, however, that the appended drawings illustrate only example embodiments and are therefore not to be considered limiting in scope.

FIG. 1 illustrates a schematic depiction of a test workbench connected to a plurality of devices, according to one embodiment.

FIG. 2 illustrates a method of performing a test, according to one embodiment.

### DETAILED DESCRIPTION

In the following description, numerous specific details are set forth to provide a more thorough understanding of the described embodiments. However, it will be apparent to one of skill in the art that the present embodiments may be practiced without one or more of these specific details. In other instances, well-known features have not been described in order to avoid obscuring the described embodiments.

Reference throughout this disclosure to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

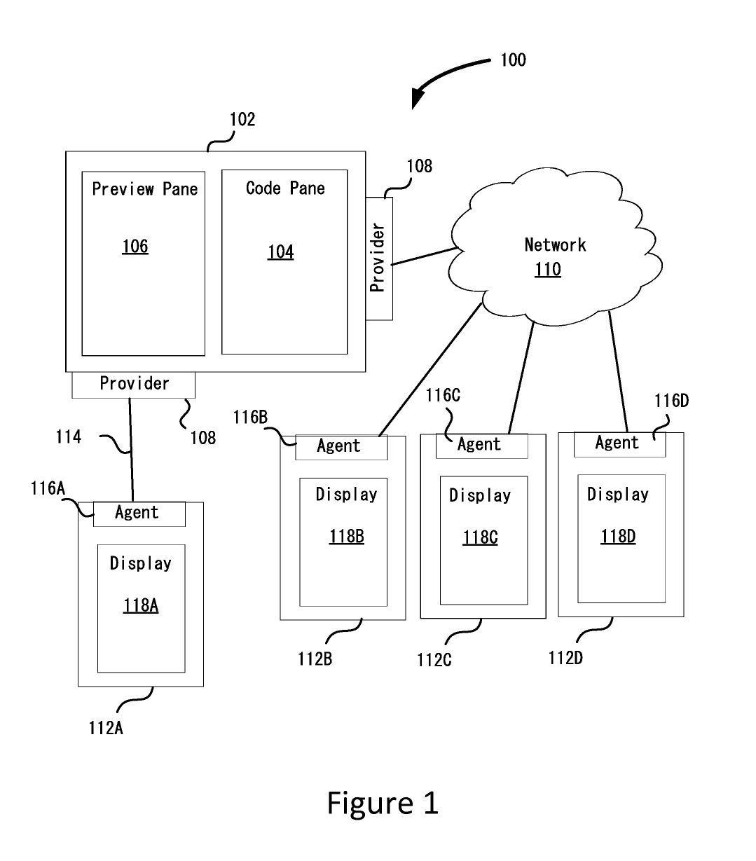

FIG. 1 illustrates a test framework 100 for testing software applications. The test framework 100 includes a test workbench 102. The test workbench 102 may be executing on a general purpose computer. The test workbench 102 may include software development tools, including a code editor, a code complier, a debugger, etc. The code editor includes a code pane 104 and an optional preview pane 106. The code pane 104 is used by a test workbench user to write programming instructions or to test existing programming instructions. In one embodiment, the code pane 104 is configured for the development of Web applications that are targeted to be deployed on different types of computing devices such as mobile devices, laptops, desktops, etc. Further, a Web application may also be deployed on a Web server, which is accessible to the computing devices through a Web browser via the Internet. The preview pane 106 may be used for displaying the graphical user interface according to the programming instructions in the code pane 104.

It should be noted that device specific emulators may be used to test applications. However, with ever increasing numbers of different types of devices, hardware, operating systems, and versions of installed rendering engines, it has become practically impossible for emulators to keep up with the changes in devices. Moreover, it is common for device manufacturers not to make available physical devices to application developers until the devices until a formal public release of the devices. In this scenario, the application developer would need to wait to develop applications for the device's platform until after the device is publicly released. The embodiments described here enable device manufacturers to provide a limited access to device's platform and operations without actually shipping the device out of their premises.

The preview pane 106 may include a switch to display a user interface using different types of webkits and/or device emulators. In one embodiment, the webkits and emulators are installed locally with the test workbench 102. For example, an Android™ emulator may be installed with the test workbench 102 to preview the user interface generated by the programming instructions in the code pane 104 as it would have been displayed by an Android™ device. One issue with the device emulators is that the preview of the user interface may appear reasonable on the emulators. However, due to differences in operating environment and specific device characteristics, the same user interface and application performance may differ when executed on a real device.

In another embodiment, instead of locally installed off-line emulators, the test workbench 102 is configured to use real time emulation. Accordingly, the test workbench 102 is connected to real devices 112A-D via one or more providers 108. It should be noted that even though a plurality of devices are shown connected to the test workbench 102, various embodiments do not require a plurality of devices connected to the test workbench 102 at a given point in time. A provider 108 is a software component that interfaces an externally connected device to the test workbench 102. The provider 108 is a software module that runs as a part of or in conjunction with the test workbench 102 and configured to remotely control at least some aspects of the externally connected devices 112A-D through respective agents 116A-D.

Each of the devices 112A-D may include an agent 116A-D. In one embodiment, a device 112A may be connected directly to the test workbench using a direct coupling 114 (e.g., a USB cable, etc.). In other embodiments, the devices 112B-D may be connected to the test workbench 102 via a network 110, which may be the Internet, WAN or LAN or any other type of network so long as the network is capable of providing a communication link between the test workbench 102 and the devices 112B-D.

Each of the agents 116A-D includes programming instructions to control some aspects of the respective devices 112A-D. In one example, an agent may have root or admin privileges to the device operation system. The agent 116A (also 116B-D) is configured to deploy or update application code in the device 112A. The agent 116A may also be configured to retrieve performance data and log files form the operating system of the device 112A. Further, the agent 116A (also 116B-D) may also be capable of launching applications, sending simulated user inputs (e.g., clicks, touch events, gestures, etc.) and data to the launched applications and obtaining screen shots of the displayed user interface (on device displays 118A-D) of the device 112A. The agent 116A collects and transmits information on the internal state of the device 112A and/or a browser application running in the device 112A, CPU, memory and disk space usage. Further, to facilitate troubleshooting and diagnosis, the agent 116A receives information requests from the provider 108 or from the test workbench 102 regarding any portion of a deployed web application and provides detailed access to the web application renderer's state, application stack, variables, and data. For runtime experiments, the agent 116A may also allow the manipulation of the web application renderer's state, web application's state and data. In one embodiment, the test workbench 102 is configured to send instructions to the agents 116A-D to initiate collection of device data. Upon receiving instructions to an agent, the agent collects requested device data and the test workbench 102 fetches the collected device data from the agent. The device data can include, by way of example and not limitation, device runtime parameters, device temperature, central processing unit (CPU) data, memory data, device configuration data, and the like.

The provider interface 108 exposes an Application Programming Interface (API) to enable the enumeration of all available/visible agents 116A-D that can be used by the user of the test workbench 102. The discovery mechanism uses an algorithm to identify each agent that is already authorized to be visible to one or more providers 108. The following is an exemplary API interface to enable the discovery of the agents 116A-D.

Agent [ ] DiscoverAgents [ ] {
// mechanism to discover agents. This code attempts to query connected systems
//to determine if they implement a particular method as prescribed by the API for the
//agents corresponding to the API exposed by the provider 108.
// this method may also checks if the connected agents includes an authorization token
or key and return only those agents that have been authorized.
//return all agents
}

After the discovery of the agents 116A-D, the provider 108 allows at least two ways to connect the test workbench 102 to the agents 116A-D. Connecting using an agent identification parameter (e.g., agent_id) provided by the discovered agents 116A-D and connecting using explicit IP address to devices. The use of devices' IP addresses may also be used for connecting to undiscovered agents.

If an attempt to connect to an agent is successful, the provider API connection method returns the information about the connected agent. In the event the attempt to connect to an agent or device fails, the return error code would indicate the reason or reasons for failure. Exemplary reasons may include network issues, incompatible authentication certificates, missing agent, etc.

Once a connection to a desired device is established through the provider 108 and the agent 116A, the provider interface also allows the users of the test workbench 102 to deploy programming instructions onto a connected device. In one embodiment, the provider interface through the provider and agent API can deploy all necessary programming instructions on to a connected device, through an agent 116A, to enable the connected device to execute the application that is developed by a user of the test workbench 102. Once deployed, the application can execute on the target device independently without any help from the test workbench 102. The test workbench 102 is configured to deploy an application on selected devices or all connected devices. The test workbench 102 is also configured to automatically detect the types of one or more connected devices and make necessary configuration changes in the programming instructions according to the types of devices, prior to deploying to the target devices. The agent side API may include methods to enable the test workbench 102 to retrieve configuration and device type data from the connected devices.

In one embodiment, after the programming instructions are deployed, the test workbench 102, through the agent API, retrieves screen-shots of the displays from one or more connected devices on which the programming instructions have been successfully deployed. The test workbench 102 may be configured to retrieve these screen-shots from the connected devices at regular pre-selected and configurable intervals. These intervals may be configured at per device level and hence can have different values. In another embodiment, the connected devices may be instructed to push to the test workbench 102, the screen-shots and/or device performance data at a pre-selected interval.

In one embodiment, the test workbench 102 may also be configured to update agent programming code and deploy the updates onto the connected devices, without deploying the full programming instructions for the application to be executed at one or more connected devices. The test workbench 102 may also be configured to retrieve current status and version of various types of deployed programming instructions from the connected devices.

In an example embodiment, the agent API performs the following processes:

Agent Start Process—The Agent (116A-D) Interface provides an API to start the process for listening to incoming requests from the provider. This API takes the credential information for the provider to authenticate the provider. Alternatively, the provider may authenticate the agent after the agent is discovered by the provider.

Listening to the Providers—The Agent Interface exposes a mechanism to enable the Providers 108 to connect to this device based on the credentials provided by the Provider. Once the Provider is successfully validated and connected, the Agent returns the device specific information to the Provider. If the connection attempt fails, the Agent returns appropriate error messages to the Provider. In one embodiment, the Agent 116A does not allow multiple concurrent providers to connect to the device.

Support for Code Deployment—The Agent 116A allows the Provider 108 to upload the code to the device and upon completion of the upload process; it updates the UI and returns the current status of the device to the Provider. The Agent supports both full and partial code deployment process.

Status Update—The Agent 116A allows the Provider 108 to access the current status of the device including the updated screenshot, application status, etc.

Disconnecting the Provider—The Agent 116A allows the Provider 108 to disconnect from the device at any time. Once the Provider 108 disconnects, the Agent will start listening for a new incoming connection requests.

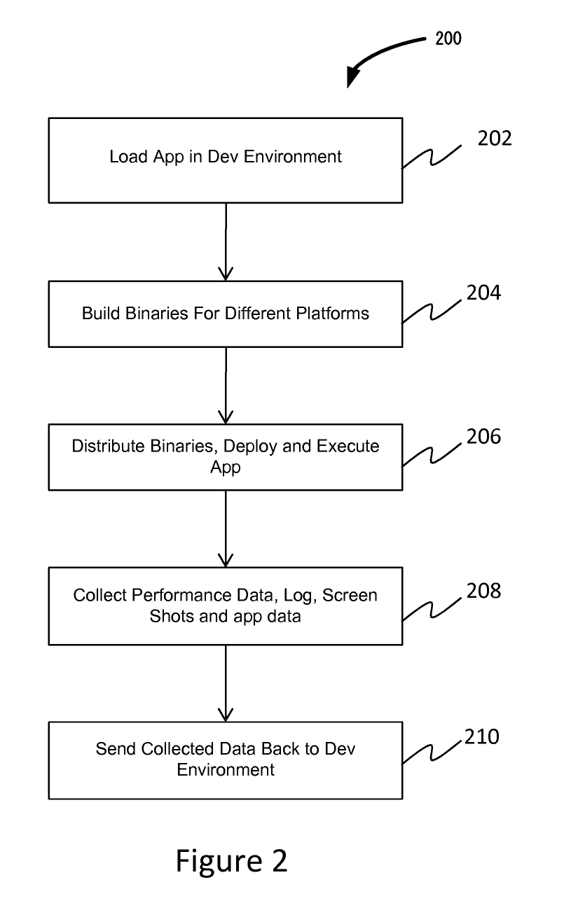

FIG. 2 illustrates a method 200 of using the test workbench setup. Accordingly, at step 202, the programming instructions of an application are loaded in the development environment (i.e., in the test workbench 102). At step 204, the programming instructions are compiled to build binaries or executable for a desired platform. For example, if the application is to be tested or deployed on an iPhone™, the executable is generated using necessary libraries and code for the target platform. At step 206, the compiled binaries or executable are distributed to the target platform via the provider 108 and the agent 116A (or 116B-D). At step 208, the test workbench 102 requests the provider 108 to collect performance data, log, screen shots, etc. from the target platform. The provider 108 requests the agent 116A (or 116B-D) to collect the requested information from the target platform. At step 210, the collected data is sent back to the test workbench 102. If a screen shot is returned to the test workbench 102, in one embodiment, the test workbench 102 may display the screen-shot in the preview pane 106 enable a user to make a determination whether the display of the user interface of the deployed application provided desired results.

While the forgoing is directed to various embodiments, other and further embodiments may be devised without departing from the basic scope thereof. For example, aspects of the various embodiments may be implemented in hardware or software or in a combination of hardware and software. One embodiment of may be implemented as a program product for use with a computer system. The program(s) or computer-readable instructions of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

We claim:

1. A method of remotely testing an application on a device, the method comprising:
connecting a development system to the device, wherein the device is hosted in a remote environment and is not directly accessible to the development system, the development system connects to the device via an agent that is coupled to the device, wherein the agent is configured to receive application data, including programming instructions to be deployed on the device and control signals from the development system and operate the device according to the control signals;
causing the agent to collect device data from the device, wherein the agent is configured to collect the device data from the device according to the control signals received from the development system; and
fetching the collected device data from the agent.

2. The method of claim 1, wherein the agent runs outside the device, the agent implements an application programming interface to communicate with the development system and the device.

3. The method of claim 1, wherein the agent is embedded in an operating system of the device, the agent implements an application programming interface to communicate with the development system and the device.

4. The method of claim 1, wherein the application data includes application installation programming instructions to enable the device to install the application or update the application if the application was previously installed on the device.

5. The method of claim 1, wherein the agent is configured to cause the device to display at least a part of the application data and to take a snapshot of a graphical user interface of the device.

6. The method of claim 5, wherein the development environment is configured to retrieve the snapshot from the agent and display the snapshot on a graphical user interface of the development system.

7. The method of claim 1, wherein the device data includes one or more of device runtime parameters, device temperature, central processing unit (CPU) data, memory data, device configuration data.

8. The method of claim 1, wherein the development system communicates with the agent via a provider.

9. The method of claim 8, wherein the provider is configured to discover the agent using a provider application programming interface.

10. The method of claim 1, where the development system is configured to use a plurality of providers, each configured to communicate with an agent in a plurality of agents that are coupled to different types of devices.

11. A computer readable storage medium containing a program which, when executed, performs an operation of remotely testing an application on a device, the operation comprising:
connecting a development system to the device, wherein the device is hosted in a remote environment and is not directly accessible to the development system, the development system connects to the device via an agent that is coupled to the device, wherein the agent is configured to receive application data, including programming instructions, for the device and control signals from the development environment and operate the device according to the control signals;
causing the agent to collect device data from the device, wherein the agent is configured to collect the device data from the device according to the control signals; and
fetching the collected device data.

12. The computer readable storage medium of claim 11, wherein the agent runs outside the device, the agent implements an application programming interface to communicate with the development system and the device.

13. The computer readable storage medium of claim 11, wherein the agent is embedded in operating system of the device, the agent implements an application programming interface to communicate with the development system and the device.

14. The computer readable storage medium of claim 11, wherein the application data includes application installation programming instructions to enable the device to install the application or update the application if the application was previously installed on the device.

15. The computer readable storage medium of claim 11, wherein the agent is configured to cause the device to display at least a part of the application data and to take a snapshot of a graphical user interface of the device.

16. The computer readable storage medium of claim 15, wherein the development environment is configured to receive the snapshot from the agent and display the snapshot on the graphical user interface of the development system.

17. The computer readable storage medium of claim 11, wherein the device data includes one or more of device runtime parameters, device temperature, central processing unit (CPU) data, memory data, device configuration data.

18. The computer readable storage medium of claim 11, wherein the development environment communicates with the agent via a provider, wherein the provider includes configuration settings to configure an Internet location of the agent.

19. The computer readable storage medium of claim 11, wherein the development environment includes a graphical user interface to display the collected device data.

20. A system for remotely testing an application on a device, the system comprising:
a development system for developing and testing programming instructions;
a provider coupled to the development system;
an agent coupled to the device, wherein the device is hosted in a remote environment and is not directly accessible to the development system;
wherein the development system is configured to connect to the device via the agent, wherein the agent is configured to receive application data, including programming instructions to be deployed on the device and control signals from the development system and operate the device according to the control signals;
wherein the development system is configured to cause the agent to collect device data from the device, the agent is configured to collect the device data from the device according to the control signals received from the development system; and
wherein the development system is configured to fetch the collected device data from the agent.
